(19) United States
(12) Patent Application Publication
(10) Pub. No.: US 2025/0364559 A1
(43) Pub. Date: Nov. 27, 2025

(54) POSITIVE ELECTRODE FOR ALL-SOLID-STATE BATTERY, POSITIVE ELECTRODE COMPOSITION, AND ALL-SOLID-STATE BATTERY INCLUDING SAME

(71) Applicant: SAMSUNG SDI CO., LTD., Gyeonggi-do (KR)

(72) Inventors: Myoungki MIN, Yongin-si, Gyeonggi-do (KR); Kwang Jong SUH, Yongin-si, Gyeonggi-do (KR); Jin-Woo KIM, Yongin-si, Gyeonggi-do (KR); Heetaek PARK, Yongin-si, Gyeonggi-do (KR)

(73) Assignee: SAMSUNG SDI CO., LTD., Gyeonggi-do (KR)

(21) Appl. No.: 18/873,176

(22) PCT Filed: Nov. 1, 2022
(86) PCT No.: PCT/KR2022/016921

§ 371 Date: Dec. 9, 2024

(30) Foreign Application Priority Data
Jun. 10, 2022 (KR) 10-2022-0070930

(51) Int. Cl. H01M 4/62; H01M 4/02; H01M 4/525; H01M 10/0562

(52) U.S. Cl. CPC H01M 4/62; H01M 4/525; H01M 10/0562; H01M 2004/021; H01M 2004/028

(57) ABSTRACT

Provided are a positive electrode for an all-solid-state battery, and a positive electrode composition, and an all-solid-state battery including the positive electrode, the positive electrode including a current collector, and a positive electrode active material layer on the current collector, wherein the positive electrode active material layer includes a positive electrode active material, a sulfide-based solid electrolyte, a binder, a conductive material, a first compound and a second compound.

### TECHNICAL FIELD

A positive electrode for an all-solid-state battery, a positive electrode composition, and an all-solid-state battery including the same are disclosed.

### BACKGROUND ART

A portable information device such as a cell phone, a laptop, smart phone, and the like or an electric vehicle has used a rechargeable lithium battery having high energy density and easy portability as a driving power source. Recently, research has been actively conducted to use a rechargeable lithium battery with high energy density as a driving power source or power storage power source for hybrid or electric vehicles.

Commercially available rechargeable lithium batteries use an electrolyte solution including a flammable organic solvent and thus have safety issues such as explosion or ignition, when crashed, penetrated, or etc. Accordingly, an all-solid-state battery that uses a solid electrolyte instead of an electrolyte solution is being proposed. All-solid-state batteries among rechargeable lithium batteries refer to batteries made of all solid materials and particularly, using a solid electrolyte. Such all-solid-state batteries are safe due to no explosion risk according to leakage of the electrolyte solution and the like and thus may be easily manufactured into a thin battery.

Such all-solid-state batteries uses a positive electrode including a sulfide-based solid electrolyte with excellent ionic conductivity in addition to a positive electrode active material. In order to commercialize the all-solid-state batteries equipped with such a positive electrode, it should be possible to form the positive electrode through a wet coating process. However, such a sulfide-based solid electrolyte may be easily deteriorated by air, moisture, and a polar solvent or under a high temperature condition and thus have a problem of deteriorating performance of the all-solid-state batteries, which should be improved.

### DISCLOSURE

### Technical Problem

Provided are a positive electrode composition capable of uniformly coating in a wet manner, drying under normal conditions such as low temperatures and atmospheric pressures of less than or equal to 100° C., and effectively suppressing deterioration of a sulfide-based solid electrolyte, and a positive electrode for an all-solid-state battery and an all-solid-state battery that enable stable cycling without deterioration of the positive electrode active material and the sulfide-based solid electrolyte and realize high capacity, high efficiency, and long cycle-life.

### Technical Solution

In an embodiment, a positive electrode for an all-solid-state battery includes a current collector, and a positive electrode active material layer on the current collector, wherein the positive electrode active material layer includes a positive electrode active material, a sulfide-based solid electrolyte, a binder, conductive material, a compound represented by Chemical Formula 1, and a compound represented by Chemical Formula 2.

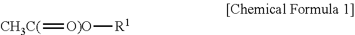

R¹ may be a C7 to C9 alkyl group,

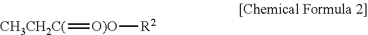

R² may be a C5 to C9 alkyl group.

In another embodiment, a positive electrode for an all-solid-state battery composition includes a positive electrode active material, a sulfide-based solid electrolyte, a binder, a conductive material, and a dispersion medium, wherein the dispersion medium includes a compound represented by Chemical Formula 1 and a compound represented by Chemical Formula 2.

In another embodiment, an all-solid-state battery includes the aforementioned positive electrode, a negative electrode, and a solid electrolyte layer between the positive electrode and negative electrode.

### Advantageous Effects

According to an embodiment, the positive electrode composition for an all-solid-state battery may be uniformly coated in a wet manner, may be dried under normal conditions, for example, at less than or equal to 100° C. or less than or equal to 80° C., and may effectively suppress the phenomenon of deterioration of a sulfide-based solid electrolyte during the battery manufacturing process. In addition, the positive electrode for an all-solid-state battery according to an embodiment and the all-solid-state battery including the same may achieve stable cycling without deterioration of the positive electrode active material and the sulfide-based solid electrolyte, and may realize high capacity, high efficiency, and long cycle-life characteristics.

### DESCRIPTION OF THE DRAWINGS

FIGS. 1 and 2 are cross-sectional views schematically illustrating an all-solid-state battery according to embodiments.

FIG. 3 is a graph of component analysis through an extraction method for the positive electrode of Example 1.

FIG. 4 is a graph of voltage according to specific capacity for the battery cells of Example 1 and Comparative Example 1, evaluating performance during the first, second, and third charge/discharge cycles.

FIG. 5 is a cycle-life characteristic evaluation graph for the battery cells of Example 1 and Comparative Example 1.

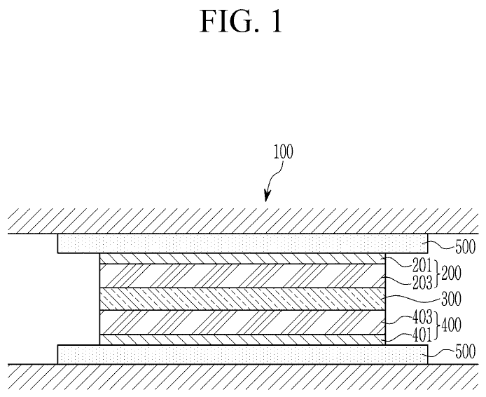

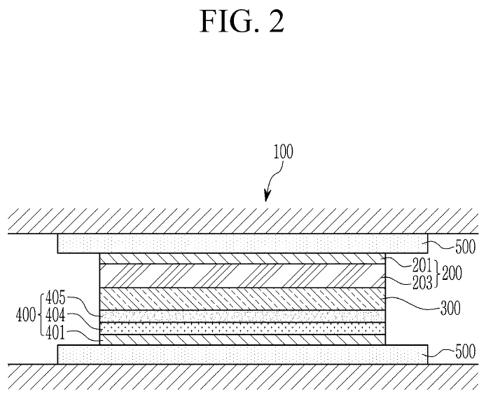

### BEST MODE

Hereinafter, specific embodiments will be described in detail so that those of ordinary skill in the art can easily implement them. However, this disclosure may be embodied in many different forms and is not construed as limited to the example embodiments set forth herein.

The terminology used herein is used to describe embodiments only, and is not intended to limit the present disclosure. The singular expression includes the plural expression unless the context clearly dictates otherwise.

As used herein, “combination thereof” means a mixture, a laminate, a composite, a copolymer, an alloy, a blend, a reaction product, and the like of the constituents.

Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, etc., are exaggerated for clarity and like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

In addition, “layer” herein includes not only a shape formed on the whole surface when viewed from a plan view, but also a shape formed on a partial surface.

In addition, the average particle diameter and average size, etc. may be measured by methods widely known to those skilled in the art, for example, by measuring with a particle size analyzer, or by measuring with a transmission electron microscope photograph or a scanning electron microscope photograph. Alternatively, the average particle diameter may be obtained by measuring the size, etc. using dynamic light scattering, performing data analysis, counting the number of particles for each particle size range, and calculating from this. Unless otherwise defined, the average particle diameter may mean a diameter (D50) of particles having a cumulative volume of 50 volume % in the particle size distribution.

Herein, “or” is not to be construed as an exclusive meaning, for example, “A or B” is construed to include A, B, A+B, and the like.

### Positive Electrode Composition

In an embodiment, a positive electrode for an all-solid-state battery composition includes a positive electrode active material, a sulfide-based solid electrolyte, binder, a conductive material, and a dispersion medium, wherein the dispersion medium includes a compound represented by Chemical Formula 1 and a compound represented by Chemical Formula 2. Herein, the positive electrode composition may also be expressed as a positive electrode active material layer composition, or a composition for forming a positive electrode active material layer.

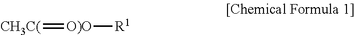

R¹ is a C7 to C9 alkyl group,

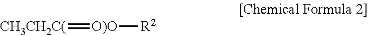

R² is a C5 to C9 alkyl group.

The C5, C7, C9, etc. indicate the number of carbon atoms. That is, R¹ may be an alkyl group having 7 to 9 carbon atoms, and R² may be an alkyl group having 5 to 9 carbon atoms. R¹ and R² may be a chain alkyl group or a cyclic alkyl group, and may be a linear or branched alkyl group.

The compound represented by Chemical Formula 1 may be expressed as a C7 to C9 alkyl acetate, and may be, for example, heptyl acetate, octyl acetate, or nonyl acetate.

The compound represented by Chemical Formula 2 may be expressed as a C5 to C9 alkyl propionate, and can be, for example, pentyl propionate, hexyl propionate, heptyl propionate, octyl propionate, or nonyl propionate.

In Chemical Formula 1, R¹ may be for example a C7 to C8 alkyl group, or a C8 to C9 alkyl group. In addition, in Chemical Formula 2, R² may be, for example, a C5 to C8 alkyl group, a C5 to C7 alkyl group, a C5 to C6 alkyl group, a C6 to C9 alkyl group, a C7 to C9 alkyl group, or a C8 to C9 alkyl group.

For all-solid-state batteries to be commercialized, it is advantageous to apply a wet coating process to the manufacturing process. However, when using a conventional polar solvent for wet coating of the positive electrode, there is a problem that the sulfide-based solid electrolyte inside the positive electrode dissolves in the polar solvent or is deteriorated by the polar solvent. Instead, when using a nonpolar solvent such as heptane, there is a problem in which the binder does not dissolve, resulting in the failure of the electrode plate to form.

On the other hand, in the positive electrode composition according to an embodiment, the dispersion medium is a kind of nonpolar solvent, and has very low reactivity with the sulfide-based solid electrolyte, and thus it does not deteriorate it, does not increase cell resistance, and also dissolves the binder well and can have an appropriate viscosity, so that a uniform coating is possible on the electrode plate, and further, harsh conditions are not required during the drying process of the electrode plate, and it is effectively dried under room temperature or relatively low temperature conditions or under normal pressure conditions, so that the problem of additional deterioration of the sulfide-based solid electrolyte may be prevented during the drying process. The positive electrode and all-solid-state battery applying these compositions can realize high capacity, high efficiency, and long cycle-life characteristics.

When only the compound represented by Chemical Formula 1 is applied to the dispersion medium in the above-mentioned positive electrode composition, high temperature conditions are required when drying the electrode plate, and at this time, there is a problem that the sulfide-based solid electrolyte is exposed to high temperature and deteriorates. In addition, when only the compound represented by Chemical Formula 2 is applied to the dispersion medium, there is a problem in that the positive electrode composition dries easily due to its low boiling point and high vapor pressure characteristics, and thus uniform coating is impossible. On the other hand, in an embodiment, because the dispersion medium includes both the compound represented by Chemical Formula 1 and the compound represented by Chemical Formula 2, uniform coating is possible and drying under normal conditions is possible at the same time, so that deterioration of the sulfide-based solid electrolyte and the electrode plate may be effectively suppressed.

A mixing ratio of the compound represented by Chemical Formula 1 and the compound represented by Chemical Formula 2 may be 1:9 to 9:1, for example, 2:8 to 9:1, 3:7 to 9:1, 4:6 to 9:1, or 4:6 to 8:2 by weight. When mixed in this ratio, the dispersion medium can dissolve the binder well and have low reactivity with the sulfide-based solid electrolyte, and the positive electrode composition including the dispersion medium can be dried under normal conditions, can be uniformly coated, and can effectively prevent the phenomenon of the sulfide-based solid electrolyte and the electrode plate from deteriorating.

In the above positive electrode composition, when the total amount of the positive electrode active material, the sulfide-based solid electrolyte, the binder, and the conductive material is 100 parts by weight, the dispersion medium may be included in an amount of 5 to 80 parts by weight, for example, 5 to 70 parts by weight, 10 to 65 parts by weight, or 15 to 65 parts by weight. When the dispersion medium is included in such an amount, the positive electrode composition may appropriately dissolve the binder, may be uniformly coated, may be dried under normal conditions, and may effectively prevent deterioration of the sulfide-based solid electrolyte and the electrode plate.

The above positive electrode composition may include 65 wt % to 95 wt % of the positive electrode active material; 4 wt % to 30 wt % of the sulfide-based solid electrolyte; 0.5 wt % to 5 wt % of the binder; and 0.1 wt % to 5 wt % of the conductive material, based on a total weight of the positive electrode active material, the sulfide-based solid electrolyte, the binder, and the conductive material. When each component is included in the content range as described above, the positive electrode composition may maximize capacity while improving cycle-life characteristics, and further improve energy density, initial charge/discharge efficiency, and cycle-life characteristics at high temperatures. A detailed description of each component will be covered in detail in the bipolar section below.

### Positive Electrode

In an embodiment, a positive electrode for an all-solid-state battery includes a current collector, and a positive electrode active material layer on the current collector, wherein the positive electrode active material layer includes a positive electrode active material, a sulfide-based solid electrolyte, a binder, conductive material, a compound represented by Chemical Formula 1, and a compound represented by Chemical Formula 2. Here, the current collector may be for example an aluminum foil, but is not limited thereto.

The positive electrode for an all-solid-state battery may be manufactured through the steps of preparing the aforementioned positive electrode composition; and coating the positive electrode composition on a current collector and drying it. In the method for manufacturing such a positive electrode, the coating is advantageously applied to an existing process as a wet coating, and uniform coating is possible by applying the positive electrode composition described above. In addition, the drying may be carried out at relatively low temperature and normal pressure, making it economical and efficient.

The drying may be carried out, for example, at 20° C. to 100° C., 30° C. to 90° C., or 50° C. to 85° C. and at atmospheric pressure.

During the above drying process, most of the compounds represented by Chemical Formula 1 and Chemical Formula 2 are vaporized and a small amount remained. Accordingly, the all-solid-state battery positive electrode can be explained as including the compound represented by Chemical Formula 1 and the compound represented by Chemical Formula 2 in addition to the positive electrode active material, sulfide-based solid electrolyte, binder, and conductive agent. These positive electrodes can realize high capacity, high efficiency, and long cycle-life without deterioration of each component, especially the sulfide-based solid electrolyte.

Based on a total weight of the positive electrode active material layer, the compound represented by Chemical Formula 1 may be included in an amount of less than or equal to 0.1 wt %, for example, 0.0001 wt % to 0.1 wt %, 0.0001 wt % to 0.05 wt %, 0.0001 wt % to 0.04 wt %, 0.0001 wt % to 0.03 wt %, 0.0001 wt % to 0.02 wt %, 0.0001 wt % to 0.01 wt %, 0.001 wt % to 0.01 wt %, 0.001 wt % to 0.005 wt %, or 0.005 wt % to 0.01 wt %. The compound represented by Chemical Formula 1, which is used as a type of dispersant in the positive electrode composition during positive electrode manufacturing, remains in this small amount in the final positive electrode active material layer.

In addition, based on a total weight of the positive electrode active material layer, the compound represented by the Chemical Formula 2 may be included in an amount of less than or equal to 0.1 wt %, for example, 0.0001 wt % to 0.1 wt %, 0.0001 wt % to 0.05 wt %, 0.0001 wt % to 0.04 wt %, 0.0001 wt % to 0.03 wt %, 0.0001 wt % to 0.02 wt %, 0.0001 wt % to 0.01 wt %, 0.001 wt % to 0.01 wt %, 0.001 wt % to 0.005 wt %, or 0.005 wt % to 0.01 wt %. The compound represented by Chemical Formula 2, which is used as a type of dispersant in the positive electrode composition during positive electrode manufacturing, remains in this small amount in the final positive electrode active material layer.

A weight ratio of the compound represented by Chemical Formula 1 and the compound represented by Chemical Formula 2 within the positive electrode active material layer may be 1:9 to 9:1, for example, 2:8 to 8:2, 3:7 to 7:3, or 4:6 to 6:4.

In addition, the compound represented by Chemical Formula 1 and the compound represented by Chemical Formula 2 used as a dispersion medium may react with each other or cause a chemical reaction with other components in the battery during the battery manufacturing process or during battery operation, and accordingly, a derivative (or modified substance) of the compound represented by Chemical Formula 1 and/or a derivative (or modified substance) of the compound represented by Chemical Formula 2 may be present in the final positive electrode active material layer.

For example, when octyl acetate and pentyl propionate are used as dispersion media in the positive electrode composition during battery manufacturing, octyl propionate may be detected in the final positive electrode active material layer by reacting with each other or by another reaction. In this case, both pentyl propionate and its derivative octyl propionate of the dispersion medium correspond to the compound represented by the Chemical Formula 2.

Additionally, the compound represented by Chemical Formula 1 and the compound represented by Chemical Formula 2 may be decomposed into alcohol form due to a type of chemical reaction during the battery manufacturing process or battery operation. That is, an alcohol-type derivative may be detected within the positive electrode active material layer. For example, the positive electrode active material layer may further include a compound represented by Chemical Formula 3.

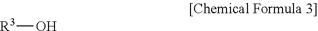

R³ is a C5 to C9 alkyl group.

In Chemical Formula 3, R³ may be an alkyl group having 5 to 9 carbon atoms, and may be a linear alkyl group or a cyclic alkyl group, and may be a linear or branched alkyl group. R³ may be, for example, an alkyl group having C5 to C7, or an alkyl group having C7 to C9. The compound represented by Chemical Formula 3 may be expressed as a C5 to C9 alcohol, and may be, for example, pentyl alcohol, hexyl alcohol, heptyl alcohol, octyl alcohol, or nonyl alcohol.

The compound represented by Chemical Formula 3 is not a component used as a dispersion medium in the manufacture of the positive electrode, but may be said to be a derivative of the compound represented by Chemical Formula 1 and/or a derivative of the compound represented by Chemical Formula 2.

Likewise, the compound represented by Chemical Formula 3 may be included in an amount of less than or equal to 0.1 wt % based on a total weight of the positive electrode active material layer, and may be included in an amount of, for example, 0.0001 wt % to 0.1 wt %, 0.0001 wt % to 0.05 wt %, 0.0001 wt % to 0.04 wt %, 0.0001 wt % to 0.03 wt %, 0.0001 wt % to 0.02 wt %, 0.0001 wt % to 0.01 wt %, 0.001 wt % to 0.01 wt %, 0.001 wt % to 0.005 wt %, or 0.005 wt % to 0.01 wt %.

### Positive Electrode Active Material

The positive electrode active material may be a compound (lithiated intercalation compound) capable of reversibly intercalating and deintercalating lithium. Examples of the positive electrode active material include a compound represented by any one of the following chemical formulas:

$${Li}_{a} {A}_{1 - b} {X}_{b} {D}_{2} ( 0.9 \leq a \leq 1.8 , 0 \leq b \leq 0.5 ) ;$$

$${Li}_{a} {A}_{1 - b} {X}_{b} {O}_{2 - c} {D}_{c} ( 0.9 \leq a \leq 1.8 , 0 \leq b \leq 0.5 , 0 \leq c \leq 0.05 ) ;$$

$${Li}_{a} {E}_{1 - b} {X}_{b} {O}_{2 - c} {D}_{c} ( 0.9 \leq a \leq 1.8 , 0 \leq b \leq 0.5 , 0 \leq c \leq 0.05 ) ;$$

$${Li}_{a} {E}_{2 - b} {X}_{b} {O}_{4 - c} {D}_{c} ( 0.9 \leq a \leq 1.8 , 0 \leq b \leq 0.5 , 0 \leq c \leq 0.05 ) ;$$

$${Li}_{a} {Ni}_{1 - b - c} {Co}_{b} {X}_{c} {D}_{α} ( 0.9 \leq a \leq 1.8 , 0 \leq b \leq 0.5 , 0 \leq c \leq 0.5 , 0 < α \leq 2 ) ;$$

$${Li}_{a} {Ni}_{1 - b - c} {Co}_{b} {X}_{c} {O}_{2 - α} {T}_{α} ( 0.9 \leq a \leq 1.8 , 0 \leq b \leq 0.5 , 0 \leq c \leq 0.05 , 0 < α < 2 ) ;$$

$${Li}_{a} {Ni}_{1 - b - c} {Co}_{b} {X}_{c} {O}_{2 - α} {T}_{2} ( 0.9 \leq a \leq 1.8 , 0 \leq b \leq 0.5 , 0 \leq c \leq 0.05 , 0 < α < 2 ) ;$$

$${Li}_{a} {Ni}_{1 - b - c} {Mn}_{b} {X}_{c} {D}_{α} ( 0.9 \leq a \leq 1.8 , 0 \leq b \leq 0.5 , 0 \leq c \leq 0.05 , 0 < α < 2 ) ;$$

$${Li}_{a} {Ni}_{1 - b - c} {Mn}_{b} {X}_{c} {O}_{2 - α} {T}_{α} ( 0.9 \leq a \leq 1.8 , 0 \leq b \leq 0.5 , 0 \leq c \leq 0.05 , 0 < α < 2 ) ;$$

$${Li}_{a} {Ni}_{1 - b - c} {Mn}_{b} {X}_{c} {O}_{2 - α} {T}_{2} ( 0.9 \leq a \leq 1.8 , 0 \leq b \leq 0.5 , 0 \leq c \leq 0.05 , 0 < α < 2 ) ;$$

$${Li}_{a} {Ni}_{b} {E}_{c} {G}_{d} {O}_{2} ( 0.9 \leq a \leq 1.8 , 0 \leq b \leq 0.9 , 0 \leq c \leq 0.5 , 0.001 \leq d \leq 0.1 ) ;$$

$${Li}_{a} {Ni}_{b} {Co}_{c} {Mn}_{d} {G}_{e} {O}_{2} ( 0.9 \leq a \leq 1.8 , 0 \leq b \leq 0.9 , 0 \leq c \leq 0.5 , 0 \leq d \leq 0.5 , 0.001 \leq e \leq 0.1 ) ;$$

$${Li}_{a} Ni {G}_{b} {O}_{2} ( 0.9 \leq a \leq 1.8 , 0.001 \leq b \leq 0.1 ) ;$$

$${Li}_{a} Co {G}_{b} {O}_{2} ( 0.9 \leq a \leq 1.8 , 0.001 \leq b \leq 0.1 ) ;$$

$${Li}_{a} {Mn}_{1 - b} {G}_{b} {O}_{2} ( 0.9 \leq a \leq 1.8 , 0.001 \leq b \leq 0.5 ) ;$$

$${Li}_{a} {Mn}_{2} {G}_{b} {O}_{4} ( 0.9 \leq a \leq 1.8 , 0.001 \leq b \leq 0.5 ) ;$$

$${Li}_{a} {Mn}_{1 - g} {G}_{g} {PO}_{4} ( 0.9 \leq a \leq 1.8 , 0 \leq g \leq 0.5 ) ;$$

$${Q O}_{2} ; {Q S}_{2} ; {Li Q S}_{2} ;$$

$${V}_{2} {O}_{5} ; L i {V}_{2} {O}_{5} ;$$

$$Li {Z O}_{2} ;$$

$$Li Ni V {O}_{4} ;$$

$${Li}_{( e - f )} {J}_{2} ( {PO}_{4} ) ( 0 \leq f \leq 2 ) ;$$

$${Li}_{( 3 - f )} {{Fe}_{2} ( {PO}_{4} )}_{3} ( 0 \leq f \leq 2 ) ;$$

$${Li}_{a} {FePO}_{4} ( 0.9 \leq a \leq 1.8 ) .$$

In the above chemical formulas, A is selected from Ni, Co, Mn, and a combination thereof; X is selected from Al, Ni, Co, Mn, Cr, Fe, Mg, Sr, V, rare earth elements and a combination thereof; D is selected from O, F, S, P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

The positive electrode active material may be a lithium-metal composite oxide, for example, lithium cobalt oxide (LCO), lithium nickel oxide (LNO), lithium nickel cobalt oxide (NC), lithium nickel cobalt aluminum oxide (NCA), lithium nickel cobalt manganese oxide (NCM), lithium manganese oxide (LMO), or lithium iron phosphate oxide (LFP).

The compounds may have a coating layer on the surface, or may be mixed with another compound having a coating layer. The coating layer may include at least one coating element compound selected from the group consisting of an oxide of a coating element, a hydroxide of a coating element, an oxyhydroxide of a coating element, an oxycarbonate of a coating element, and a hydroxyl carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a combination thereof. For example, the coating layer may include Li₂O—ZrO₂ (LZO). In the coating layer forming process, a method that does not adversely affect the physical properties of the positive electrode active material, for example, spray coating, dipping, and the like may be used.

The positive electrode active material may include, for example, one or more of a lithium-metal composite oxide represented by Chemical Formula 11.

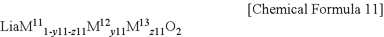

In Chemical Formula 11, 0.9≤a≤1.8, 0≤y11≤1, 0≤z11≤1, 0≤y11+z11<1, and M¹¹, M¹², and M¹³ are each independently at least one element selected from Ni, Co, Mn, Al, Mg, Ti, and Fe, and a combination thereof.

For example, M¹¹ may be Ni, and M¹² and M¹³ may each independently be a metal such as Co, Mn, Al, Mg, Ti; or Fe. In a specific embodiment, M¹¹ may be Ni, M¹² may be Co, and M¹³ may be Mn or Al, but they are not limited thereto.

In an embodiment, the positive electrode active material may include a lithium nickel-based composite oxide represented by Chemical Formula 12.

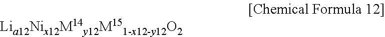

In Chemical Formula 12, 0.9≤a12≤1.8, 0.3≤x12≤1, 0≤y12≤0.7 and M¹⁴ and M¹⁵ are each independently at least one element selected from Al, B, Ba, Ca, Ce, Co, Cr, F, Fe, Mg, Mn, Mo, Nb, P, S, Si, Sr, Ti, V, W, and Zr.

The positive electrode active material may include, for example, a lithium nickel cobalt-based oxide represented by Chemical Formula 13.

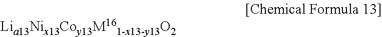

In Chemical Formula 13, 0.9≤a13≤1.8, 0.3≤x13<1, 0<y13≤0.7, and M¹⁶ is at least one element selected from Al, B, Ba, Ca, Ce, Cr, F, Fe, Mg, Mn, Mo, Nb, P, S, Si, Sr, Ti, V, W, and Zr.

In Chemical Formula 13, 0.3≤x13≤0.99 and 0.01≤y13≤0.7, 0.4≤x13≤0.99 and 0.01≤y13≤0.6, or 0.5≤x13≤0.99 and 0.01≤y13≤0.5, or 0.6≤x13≤0.99 and 0.01≤y13≤0.4, or 0.7≤x13≤0.99 and 0.01≤y13≤0.3, 0.8≤x13≤0.99 and 0.01≤y13≤0.2, or 0.9≤x13≤0.99 and 0.01≤y13≤0.1.

In the lithium nickel-based composite oxide, a content of nickel may be greater than or equal to 30 mol %, for example greater than or equal to 40 mol %, greater than or equal to 50 mol %, greater than or equal to 60 mol %, greater than or equal to 70 mol %, greater than or equal to 80 mol %, or greater than or equal to 90 mol % and less than or equal to 99.9 mol % or less than or equal to 99 mol % based on the total amount of metals excluding lithium. For example, in the lithium nickel-based composite oxide, the content of nickel may be higher than that of each of the other metals such as cobalt, manganese, aluminum, and the like. When the content of nickel satisfies the ranges, the positive electrode active material may realize high capacity and exhibit excellent battery performance.

The positive electrode active material may have an average particle diameter of 1 μm to 25 μm, for example 4 μm to 25 μm, 5 μm to 20 μm, 8 μm to 20 μm, or 10 μm to 18 μm. The positive electrode active material having a particle diameter within the ranges may be harmoniously mixed with the other components in the positive electrode active material layer and realize high capacity and high energy density.

The positive electrode active material may be in the form of secondary particles formed by aggregating a plurality of primary particles, or may be in the form of single particles. In addition, the positive electrode active material may have a spherical or near-spherical shape, or may have a polyhedral or amorphous shape.

Based on the total weight of the positive electrode active material layer, the positive electrode active material may be included in an amount of 55 wt % to 99.7 wt %, for example 74 wt % to 89.8 wt %, When included within the ranges, capacity of the all-solid-state battery may not only be maximized, but also cycle-life characteristics thereof may be improved.

### Solid Electrolyte

The solid electrolyte may be an inorganic solid electrolyte such as a sulfide-based solid electrolyte, an oxide-based solid electrolyte, or a solid polymer electrolyte.

In an embodiment, the solid electrolyte may be a sulfide-based solid electrolyte with excellent ionic conductivity. The sulfide-based solid electrolyte may be for example Li₂S—P₂S₅, Li₂S—P₂S—LiX (wherein X is a halogen element, for example I or Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (wherein m and n are an integer, respectively, and Z is Ge, Zn, or Ga), Li₂S—GeS₂, Li₂S—SiS₂—Li₃PO₄, Li₂S—SiS₂-LiₚMO_{q} (wherein p and q are integers, and M is P, Si, Ge, B, Al, Ga, or In), and the like.

The sulfide-based solid electrolyte may be obtained, for example, by mixing Li₂S and P₂S₅ in a molar ratio of 50:50 to 90:10, or in a molar ratio of 50:50 to 80:20, Within the above mixing ratio range, a sulfide-based solid electrolyte having excellent ionic conductivity may be prepared. The ionic conductivity may be further improved by adding SiS₂, GeS₂, B₂S₃, and the like as other components thereto. As a mixing method, mechanical milling or a solution method may be applied. Mechanical milling is a method in which the starting materials and the ball are put in the reactor and stirred vigorously to micronize the starting materials to mix them. In the case of using the solution method, a solid electrolyte may be obtained as a precipitate by mixing the starting materials in a solvent. In addition, calcining may be additionally performed after mixing. When additional calcining is performed, crystals of the solid electrolyte may become more rigid.

For example, the solid electrolyte may be an argyrodite-type sulfide-based solid electrolyte. The sulfide-based solid electrolyte may be, for example, LiₐM_{b}P_{c}S_{d}Aₑ ((a, b, c, d and e are all 0 or more and 12 or less, M is Ge, Sn, Si or a combination thereof, and A is F, Cl, Br, or I), and specifically Li₃PS₄, Li₇P₃S₁₁, Li₆PS₅Cl, Li₆PS₅Br, Li₆PS₅I, and the like. The sulfide-based solid electrolyte has high ionic conductivity close to the ionic conductivity of 10⁻⁴ to 10⁻² S/cm, which is the ionic conductivity of general liquid electrolytes at room temperature, and thus a close bond with the positive electrode active material and the like may be formed without causing a decrease in ionic conductivity, and further, a close interface between the electrode layer and the solid electrolyte layer may be formed. In an all-solid-state battery including the same, battery performance such as rate capability, coulombic efficiency, and cycle-life characteristics may be improved.

The sulfide-based solid electrolyte may be amorphous or crystalline, and may be in a mixed state.

The solid electrolyte may be an oxide-based inorganic solid electrolyte other than a sulfide-based material. The oxide-based inorganic solid electrolyte may include, for example, Li₁₊ₓTi₂₋ₓAl(PO₄)₃ (LTAP) (0≤x≤4), Li_{1+x+y}AlₓTi₂₋ₓSi_{y}P_{3-y}O₁₂ (0<x<2, 0≤y<3), BaTiO₃, Pb(Zr,Ti)O₃ (PZT), Pb₁₋ₓLaₓZr_{1-y}Ti_{y}O₃ (PLZT) (0≤x<1, 0≤y<1), PB(Mg₃Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y}(PO₄)₃, 0<x<2, 0<y<3), Li_{1+x+y}(Al, Ga)ₓ(Ti, Ge)₂₋ₓSi_{y}P_{3-y}O₁₂ (0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂-based ceramics, Garnet-based ceramics Li₃₊ₓLa₃M₂O₁₂ (wherein M=Te, Nb, or Zr; x is an integer of 1 to 10), or a mixture thereof.

The solid electrolyte may be in a form of particles, and the average particle diameter (D50) may be less than or equal to 5.0 μm, for example, 0.1 μm to 5.0 μm, 0.5 μm to 5.0 μm, 0.5 μm to 4.0 μm, 0.5 μm to 3.0 μm, 0.5 μm to 2.0 μm, or 0.5 μm to 1.0 μm. Such a solid electrolyte can effectively penetrate between positive electrode active materials, and has excellent contact with the positive electrode active material and connectivity between solid electrolyte particles.

Based on the total weight of the positive electrode active material layer, the solid electrolyte may be included in an amount of 0.1 wt % to 35 wt %, for example 1 wt % to 35 wt %, 5 wt % to 30 wt %, 8 wt % to 25 wt %, or 10 wt % to 20 wt %. Additionally, based on a total weight of the positive electrode active material and solid electrolyte in the positive electrode active material layer, 65 wt % to 99 wt % of the positive electrode active material and 1 wt % to 35 wt % of the solid electrolyte may be included, and for example, 80 wt % to 90 wt % of the positive electrode active material and 10 wt % to 20 wt % of the solid electrolyte may be included. If the solid electrolyte is included in the positive electrode at this amount, the efficiency and cycle-life characteristics of the all-solid-state battery can be improved without reducing the capacity.

### Binder

The binder improves binding properties of positive electrode active material particles with one another and with a current collector. Examples of the binder may be polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, a vinylidenefluoride-hexafluoropropylene copolymer, polyethylene, polypropylene, a styrene butadiene rubber, an acrylated styrene butadiene rubber, polyacrylonitrile, an epoxy resin, nylon, poly(meth)acrylate, polymethyl(meth)acrylate, and the like, but is not limited thereto.

Among them, the binder according to an embodiment one or more selected from polyvinylidene fluoride, a vinylidene fluoride-hexafluoropropylene copolymer, polytetrafluoroethylene, a styrene butadiene rubber, polyacrylonitrile, and polymethyl (meth) acrylate. These binders may be well dissolved in the compound represented by Chemical Formula 1 and the compound represented by Chemical Formula 2 as a dispersion medium in the positive electrode composition, and thus uniform coating may be possible and excellent electrode plate performance may be realized.

The binder may be included in an amount of 0.1 wt % to 5 wt %, or 0.1 wt % to 3 wt %, based on the total weight of each component of the positive electrode for an all-solid-state battery or the total weight of the positive electrode active material layer. In the above content range, the binder may sufficiently exhibit adhesive ability without degrading battery performance.

### Conductive Material

The conductive material is used to impart conductivity to the electrode, and any electronically conductive material without causing chemical change may be used. The conductive material may be, for example, a carbon-based material such as natural graphite, artificial graphite, carbon black, acetylene black, ketjen black, a carbon fiber, a carbon nanofiber, or a carbon nanotube; a metal-based material including copper, nickel, aluminum, silver and the like and in the form of a metal powder or a metal fiber; a conductive polymer such as a polyphenylene derivative; or a mixture thereof.

The conductive material may be included in an amount of 0.1 wt % to 5 wt %, or 0.1 wt % to 3 wt %, based on the total weight of each component of the positive electrode for an all-solid-state battery or the total weight of the positive electrode active material layer. In the above content range, the conductive material may improve electrical conductivity without degrading battery performance.

The positive electrode active material layer may include a conductive material in an amount of 55 wt % to 99.7 wt % of the positive electrode active material; 0.1 wt % to 35 wt % of the solid electrolyte; 0.1 wt % to 5 wt % of the binder; and 0.1 wt % to 5 wt % of the conductive material based on the total weight of the positive electrode active material, the solid electrolyte, the binder, and the conductive material. As a specific example, 74 wt % to 89.8 wt % of the positive electrode active material; 10 wt % to 20 wt % of the solid electrolyte; 0.1 wt % to 3 wt % of the binder; and 0.1 wt % to 3 wt % of the conductive material may be included. When mixed in the above content range, cycle-life characteristics of the battery may be improved while maximizing the capacity.

### All-Solid-State Battery

In an embodiment, provided is an all-solid-state battery including the aforementioned positive electrode, negative electrode, and a solid electrolyte layer between the positive electrode and negative electrode. The all-solid-state battery may also be expressed as an all-solid-state rechargeable battery, or an all-solid-state rechargeable lithium battery.

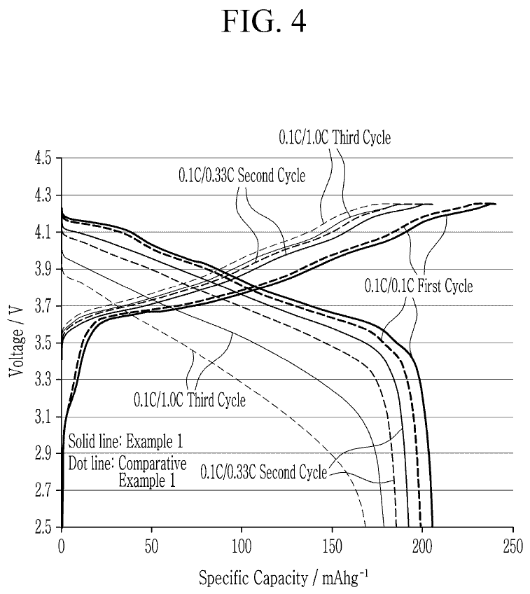

FIG. 4 is a cross-sectional view of an all-solid-state battery according to an embodiment. Referring to FIG. 4, the all-solid-state battery 100 has a structure in which an electrode assembly in which a negative electrode 400 including a negative electrode current collector 401 and a negative electrode active material layer 403; a solid electrolyte layer 300; and a positive electrode 200 including the positive electrode active material layer 203 and a positive electrode current collector 201 are stacked may be accommodated in a case such as a pouch. The all-solid-state battery 100 may further include an elastic layer 500 on the outer side of at least one of the positive electrode 200 and the negative electrode 400. Although one electrode assembly including the negative electrode 400, the solid electrolyte layer 300, and the positive electrode 200 is illustrated in FIG. 4, an all-solid-state battery may be manufactured by stacking two or more electrode assemblies.

### Negative Electrode

The negative electrode for an all-solid-state battery may include, for example, a current collector and a negative electrode active material layer on the current collector. The negative electrode active material layer includes a negative electrode active material, and may further include a binder, a conductive material, and/or a solid electrolyte.

The negative electrode active material may include a material that reversibly intercalates/deintercalates lithium ions, a lithium metal, a lithium metal alloy, a material capable of doping/dedoping lithium, or transition metal oxide.

The material that reversibly intercalates/deintercalates lithium ions may include, for example crystalline carbon, amorphous carbon, or a combination thereof as a carbon-based negative electrode active material. The crystalline carbon may be irregular, or sheet, flake, spherical, or fiber shaped natural graphite or artificial graphite and the amorphous carbon may be a soft carbon, a hard carbon, a mesophase pitch carbonization product, calcined coke, and the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOₓ (0<x<2), a Si-Q alloy (wherein Q is an alkali metal, an alkaline-earth metal, a Group 13 element, a Group 14 element, a Group 15 element, a Group 16 element, a transition metal, a rare earth element, and a combination thereof, but not Si) and the Sn-based negative electrode active material may include Sn, SnO₂, an Sn—R alloy (wherein R is an alkali metal, an alkaline-earth metal, a Group 13 element, a Group 14 element, a Group 15 element, a Group 16 element, a transition metal, a rare earth element, and a combination thereof, but not Sn). At least one of these materials may be mixed with SiO₂. The elements Q and R may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and a combination thereof.

The silicon-carbon composite may be, for example, a silicon-carbon composite including a core including crystalline carbon and silicon particles and an amorphous carbon coating layer disposed on the surface of the core. The crystalline carbon may be artificial graphite, natural graphite, or a combination thereof. The amorphous carbon precursor may be a coal-based pitch, mesophase pitch, petroleum-based pitch, coal-based oil, petroleum-based heavy oil, or a polymer resin such as a phenol resin, a furan resin, or a polyimide resin. In this case, the content of silicon may be 10 wt % to 50 wt % based on the total weight of the silicon-carbon composite. In addition, the content of the crystalline carbon may be 10 wt % to 70 wt % based on the total weight of the silicon-carbon composite, and the content of the amorphous carbon may be 20 wt % to 40 wt % based on the total weight of the silicon-carbon composite. In addition, a thickness of the amorphous carbon coating layer may be 5 nm to 100 nm.

An average particle diameter (D50) of the silicon particles may be 10 nm to 20 μm, for example 10 nm to 200 nm. The silicon particles may exist in an oxidized form, and in this case, an atomic content ratio of Si:O in the silicon particles indicating a degree of oxidation may be a weight ratio of 99:1 to 33:67. The silicon particles may be SiOₓ particles, and in this case, the range of x in SiOₓ may be greater than 0 and less than 2.

The Si-based negative electrode active material or Sn-based negative electrode active material may be mixed with the carbon-based negative electrode active material. A mixing ratio of the Si-based negative electrode active material or Sn-based negative electrode active material; and carbon-based negative electrode active material may be a weight ratio of 1:99 to 90:10.

In the negative electrode active material layer, the negative electrode active material may be included in an amount of 95 wt % to 99 wt % based on the total weight of the negative electrode active material layer.

In an embodiment, the negative electrode active material layer further includes a binder, and may optionally further include a conductive material. An amount of the binder in the negative electrode active material layer may be 1 wt % to 5 wt % based on the total weight of the negative electrode active material layer. In addition, when the conductive material is further included, the negative electrode active material layer may include 90 wt % to 98 wt % of the negative electrode active material, 1 wt % to 5 wt % of the binder, and 1 wt % to 5 wt % of the conductive material.

The binder serves to well adhere the negative electrode active material particles to each other and also to adhere the negative electrode active material to the current collector. The binder may be a water-insoluble binder, a water-soluble binder, or a combination thereof.

Examples of the water-insoluble binder include polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoro ethylene, polyvinylidene fluoride, polyethylene, polypropylene, polyamideimide, polyimide, or a combination thereof.

The water-soluble binder may include a rubber binder or a polymer resin binder. The rubber binder may be selected from a styrene-butadiene rubber, an acrylated styrene-butadiene rubber, an acrylonitrile-butadiene rubber, an acrylic rubber, a butyl rubber, a fluororubber, and a combination thereof. The polymer resin binder may be selected from polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, and a combination thereof.

When a water-soluble binder is used as the negative electrode binder, a cellulose-based compound capable of imparting viscosity may be further included. As the cellulose-based compound, one or more of carboxymethyl cellulose, hydroxypropylmethyl cellulose, methyl cellulose, or alkali metal salts thereof may be mixed and used. The alkali metal may be Na, K, or Li. The amount of the thickener used may be 0.1 parts by weight to 3 parts by weight based on 100 parts by weight of the negative electrode active material.

The conductive material is included to provide electrode conductivity and any electrically conductive material may be used as a conductive material unless it causes a chemical change. Examples of the conductive material include a carbon-based material such as natural graphite, artificial graphite, carbon black, acetylene black, ketjen black, a carbon fiber, a carbon nanofiber, a carbon nanotube, and the like; a metal-based material of a metal powder or a metal fiber including copper, nickel, aluminum silver, and the like; a conductive polymer such as a polyphenylene derivative; or a mixture thereof.

The negative electrode current collector may include one selected from a copper foil, a nickel foil, a stainless steel foil, a titanium foil, a nickel foam, a copper foam, a polymer substrate coated with a conductive metal, and a combination thereof.

Meanwhile, as an example, the negative electrode for an all-solid-state battery may be a precipitation-type negative electrode. The precipitation-type negative electrode does not have a negative electrode active material when assembling a battery, but lithium metal is precipitated during charging of the battery, which means a negative electrode serving as a negative electrode active material.

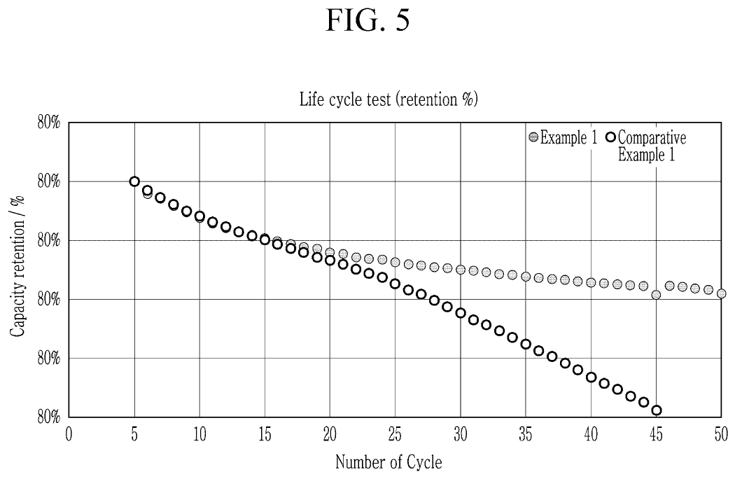

FIG. 5 is a schematic cross-sectional view of an all-solid-state battery including a precipitation-type negative electrode. Referring to FIG. 5, the precipitation-type negative electrode 400′ may include the current collector 401 and a negative electrode catalyst layer 405 disposed on the current collector. The all-solid-state battery having this precipitation-type negative electrode 400′ starts to be initially charged in absence of a negative electrode active material, and a lithium metal with high density and the like are precipitated between the current collector 401 and the negative electrode catalyst layer 405 during the charge and form a lithium metal layer 404, which may work as a negative electrode active material. Accordingly, the precipitation-type negative electrode 400′, in the all-solid-state battery which is more than once charged, may include the current collector 401, the lithium metal layer 404 on the current collector, and the negative electrode catalyst layer 405 on the metal layer 404. The lithium metal layer 404 means a layer on which lithium metal or the like is deposited during the charging process of the battery and may be referred to as a metal layer or a negative electrode active material layer.

The negative electrode catalyst layer 405 may include a metal and/or a carbon material which plays a role of a catalyst.

The metal may include, for example, gold, platinum, palladium, silicon, silver, aluminum, bismuth, tin, zinc, or a combination thereof, and may be composed of one selected therefrom or an alloy of more than one. An average particle diameter (D50) of the metal may be less than or equal to 4 μm, for example 10 nm to 4 μm, 10 nm to 2 μm, or 10 nm to 1 μm.

The carbon material may be, for example, crystalline carbon, non-graphitic carbon, or a combination thereof. The crystalline carbon may be, for example, at least one selected from natural graphite, artificial graphite, mesophase carbon microbead, and a combination thereof. The non-graphite-based carbon may be at least one selected from carbon black, activated carbon, acetylene black, denka black, ketjen black, furnace black, graphene, and a combination thereof.

When the negative electrode catalyst layer 405 includes the metal and the carbon material, the metal and the carbon material may be, for example, mixed in a weight ratio of 1:10 to 1:2, 1:10 to 2:1, 5:1 to 1:1, or 4:1 to 2:1, In this case, the precipitation of the lithium metal may be effectively promoted and improve characteristics of the all-solid-state battery. The negative electrode catalyst layer 405 may include, for example, a carbon material on which a catalyst metal is supported or a mixture of metal particles and carbon material particles.

The negative electrode catalyst layer 405 may further include a binder, and the binder may be, for example, a conductive binder. In addition, the negative electrode catalyst layer 405 may further include a filler, a dispersant, an ion conductive material, and the like, which are general additives.

A thickness of the negative electrode catalyst layer 405 may be for example 1 μm to 20 μm, 2 μm to 10 μm, or 3 μm to 7 μm. In addition, the thickness of the negative electrode catalyst layer 405 may be less than or equal to 50%, less than or equal to 20%, or less than or equal to 5% of that of the positive electrode active material layer. When the thickness is too thin, the negative electrode catalyst layer 405 may be destroyed by the lithium metal layer 404, but when the thickness is too thick, density of the all-solid-state battery may be deteriorated, increasing internal resistance.

The precipitation-type negative electrode 400′ may further include a thin film, for example, on the surface of the current collector, that is, between the current collector and the negative electrode catalyst layer. The thin film may include an element capable of forming an alloy with lithium. The element capable of forming an alloy with lithium may be, for example, gold, silver, zinc, tin, indium, silicon, aluminum, bismuth, and the like, which may be used alone or an alloy of more than one. The thin film may further planarize a precipitation shape of the lithium metal layer 404 and much improve characteristics of the all-solid-state battery. The thin film may be formed, for example, in a vacuum deposition method, a sputtering method, a plating method, and the like. The thin film may have, for example, a thickness of 1 nm to 800 nm, or 100 nm to 500 nm.

The lithium metal layer 404 may include a lithium metal or a lithium alloy. The lithium alloy may be, for example, a Li—Al alloy, a Li—Sn alloy, a Li—In alloy, a Li—Ag alloy, a Li—Au alloy, a Li—Zn alloy, a Li—Ge alloy, or a Li—Si alloy.

A thickness of the lithium metal layer 404 may be 1 μm to 500 μm, 1 μm to 200 μm, 1 μm to 100 μm, or 1 μm to 50 μm. If the thickness of the lithium metal layer 404 is too thin, it is difficult to perform the role of a lithium storage, and if it is too thick, the battery volume may increase and performance may deteriorate.

When applying such a precipitation-type negative electrode, the negative electrode catalyst layer 405 may serve to protect the lithium metal layer 404 and suppress the precipitation growth of lithium dendrite. Accordingly, short circuit and capacity degradation of the all-solid-state battery may be suppressed and cycle-life characteristics can be improved.

### Solid Electrolyte Layer

The solid electrolyte layer 300 includes a solid electrolyte, and the solid electrolyte may be an inorganic solid electrolyte such as a sulfide-based solid electrolyte, an oxide-based solid electrolyte, or a solid polymer electrolyte. Description of the types of solid electrolytes is omitted as they are described above.

For example, the solid electrolyte included in the positive electrode 200 and the solid electrolyte included in the solid electrolyte layer 300 may include the same compound, and may be, for example, the same sulfide-based solid electrolyte, for example, the same argyrodite-type sulfide-based solid electrolyte. In this case, the overall performance of the all-solid-state battery may be improved and stable operation is possible.

Additionally, the average particle diameter (D50) of the solid electrolyte included in the positive electrode 200 may be smaller than the average particle diameter (D50) of the solid electrolyte included in the solid electrolyte layer 300. In this case, the energy density of the all-solid-state battery may be maximized while increasing the mobility of lithium ions to improve the overall performance. For example, the average particle diameter (D50) of the solid electrolyte included in the positive electrode 200 may be 0.5 to 2.0 μm, or 0.5 μm to 1.5 μm, and the average particle diameter (D50) of the solid electrolyte included in the solid electrolyte layer 300 may be 2.1 μm to 5.0 μm, or 2.1 μm to 4.0 μm, or 2.5 μm to 3.5 μm. When this particle size range is satisfied, the energy density of the all-solid-state battery can be maximized and the transfer of lithium ions is facilitated, thereby suppressing resistance and thus improving the overall performance of the all-solid-state battery. Herein, the average particle diameter (D50) of the solid electrolyte may be measured through a particle size analyzer using a laser diffraction method. Alternatively, about 30 random particles are selected from a microscope image such as a scanning electron microscope, their particle sizes are measured, to obtain a particle size distribution, and to calculate the D50 value from it.

The solid electrolyte layer may further include a binder in addition to the solid electrolyte. At this time, the binder may be a styrene butadiene rubber, polytetrafluoroethylene, polyvinylidene fluoride, polyethylene, an acrylate polymer, or a combination thereof, but is not limited thereto, and anything used as a binder in the art can be used. The acrylate-based polymer may be, for example, butyl acrylate, polyacrylate, polymethacrylate, or a combination thereof.

The solid electrolyte layer may be formed by adding a solid electrolyte to a binder solution, coating it on a base film, and drying it. The solvent of the binder solution may be isobutyryl isobutyrate, xylene, toluene, benzene, hexane or a combination thereof, or may be the aforementioned compound represented by Chemical Formula 1 and/or compound represented by Chemical Formula 2. Because the solid electrolyte layer forming process is widely known in the art, detailed description will be omitted.

A thickness of the solid electrolyte layer may be, for example, 10 μm to 150 μm.

The solid electrolyte layer may further include an alkali metal salt, and/or an ionic liquid, and/or a conductive polymer.

The alkali metal salt may be, for example, a lithium salt. A content of the lithium salt in the solid electrolyte layer may be greater than or equal to 1 M, for example, 1 M to 4 M. In this case, the lithium salt may improve ionic conductivity by improving lithium ion mobility of the solid electrolyte layer.

The lithium salt may include, for example, LiSCN, LiN(CN)₂, Li(CF₃SO₂)₃C, LiC₄F₉SO₃, LiN(SO₂CF₂CF₃)₂, LiCl, LiF, LiBr, LiI, LiB(C₂O₄)₂, LiBF₄, LiBF₃(C₂F₅), lithium bis(oxalato) borate (LiBOB), lithium oxalyldifluoroborate (LIODFB), lithium difluoro(oxalato)borate (LiDFOB), lithium bis(trifluoro methanesulfonyl)imide (LiTFSI, LiN(SO₂CF₃)₂), lithium bis(fluorosulfonyl)imide (LiFSI, LiN(SO₂F)₂), LiCF₃SO₃, LiAsF₆, LiSbF₆, LiClO₄ or a mixture thereof.

Additionally, the lithium salt may be an imide-based lithium salt. For example, the imide-based lithium salt may be lithium bis(trifluoro methanesulfonyl)imide (LiTFSI, LiN(SO₂CF₃)₂), or lithium bis(fluorosulfonyl)imide (LiFSI, LiN(SO₂F)₂). The lithium salt may maintain or improve ionic conductivity by appropriately maintaining chemical reactivity with the ionic liquid.

The ionic liquid has a melting point below room temperature, so it is in a liquid state at room temperature and refers to a salt or room temperature molten salt composed of ions alone.

The ionic liquid may be a compound including at least one cation selected from a) ammonium-based, pyrrolidinium-based, pyridinium-based, pyrimidinium-based, imidazolium-based, piperidinium-based, pyrazolium-based, oxazolium-based, pyridazinium-based, phosphonium-based, sulfonium-based, triazolium-based, and a mixture thereof, and b) at least one anion selected from BF₄⁻, PF₆⁻, AsF₆⁻, SbF₆⁻, AlCl₄⁻, HSO₄⁻, ClO₄⁻, CH₃SO₃⁻, CF₃CO₂⁻, Cl⁻, Br⁻, I⁻, BF₄⁻, SO₄⁻, CF₃SO₃⁻, (FSO₂)₂N⁻, (C₂F₅SO₂)₂N⁻, (C₂F₅SO₂)(CF₃SO₂)N⁻, and (CF₃SO₂)₂N⁻.

The ionic liquid may be, for example, one or more selected from N-methyl-N-propylpyrrolidinium bis(trifluoromethanesulfonyl)imide, N-butyl-N-methylpyrrolidium bis(3-trifluoromethylsulfonyl) imide, 1-butyl-3-methylimidazolium bis(trifluoromethylsulfonyl)amide, and 1-ethyl-3-methylimidazolium bis(trifluoromethylsulfonyl)amide.

A weight ratio of the solid electrolyte and the ionic liquid in the solid electrolyte layer may be 0.1:99.9 to 90:10, for example, 10:90 to 90:10, 20:80 to 90:10, 30:70 to 90:10, 40:60 to 90:10, or 50:50 to 90:10. The solid electrolyte layer satisfying the above ranges may maintain or improve ionic conductivity by improving the electrochemical contact area with the electrode. Accordingly, the energy density, discharge capacity, rate capability, etc. of the all-solid-state battery may be improved.

An all-solid-state battery according to an embodiment may be manufactured by sequentially stacking a positive electrode, a solid electrolyte, and a negative electrode to prepare a stack, and then pressurizing the stack.

The compression may be performed for example at 25° C. to 90° C. under a pressure of less than or equal to 550 MPa, less than or equal to 500 MPa, or for example 400 MPa to 500 MPa. The compression may be for example isostatic press, roll press, or plate press.

The all-solid-state battery may be a unit battery having a structure of positive electrode/solid electrolyte layer/negative electrode, a bicell having a structure of positive electrode/solid electrolyte layer/negative electrode/solid electrolyte layer/positive electrode, or a stacked battery having a structure that the unit cells are repetitively stacked.

The shape of the all-solid-state battery is not particularly limited, and may be, for example, coin-shaped, button-shaped, sheet-shaped, stacked-shaped, cylindrical, flat, etc. In addition, the all-solid-state battery may also be applied to a medium-to-large batteries used in electric vehicles and the like. For example, the all-solid-state battery may also be used in a hybrid vehicle such as a plug-in hybrid electric vehicle (PHEV). In addition, the all-solid-state battery may be applied to an energy storage system (ESS) storing a large amount of power and also to an electric bicycle, a power tool, or the like.

### MODE FOR INVENTION

Hereinafter, examples of the present invention and comparative examples are described. However, the examples are for the purpose of illustration and are not to be construed as limiting the present invention.

### Example 1

### 1. Manufacturing of Positive Electrode

85 wt % of a LiNi_{0.9}Co_{0.05}Mn_{0.05}O₂ positive electrode active material coated with Li₂O—ZrO₂, 13.5 wt % of a Li₆PS₅Cl lithium argyrodite-type solid electrolyte, 1.0 wt % of a polyvinylidene fluoride binder, and 0.5 wt % of a carbon nanotube conductive material were prepared and then, added to a dispersion medium prepared by mixing octyl acetate (OA) and pentyl propionate (PPP) in a weight ratio of 1:1. The obtained mixture was added to a Thinky mixer and then, stirred by adding 2 mm zirconia balls thereto to prepare a positive electrode composition. A content of the dispersion medium is 30 parts by weight based on 100 parts by weight of solid content. The solid content represents a sum of the positive electrode active material, solid electrolyte, binder, and conductive material.

The prepared positive electrode composition was bar-coated on a positive electrode current collector and dried at 80° C. in a convection oven for 10 minutes to manufacture a positive electrode having a positive electrode active material layer on the current collector.

2. Manufacturing of all-Solid-State Battery Cells

### (1) Manufacturing of Solid Electrolyte Layer

Li₆PS₅Cl (D50=3 μm) of an argyrodite type solid electrolyte was added to a binder solution prepared by dissolving an acryl-based binder (SX-A334, Zeon Corp.) in an isobutyryl isobutyrate (IBIB) solvent and then, stirred in the Thinky mixter to adjust its viscosity, After adjusting the viscosity, 2 mm zirconia balls are added thereto and then, stirred again with the Thinky mixer, preparing slurry. In the slurry, 98.5 wt % of the solid electrolyte and 15 wt % of the binder are included. The slurry is coated on a release PET film with a bar coater and dried at room temperature, forming a solid electrolyte layer.

### (2) Manufacturing of Negative Electrode

Carbon black having a primary particle diameter (D50) of about 30 nm and silver (Ag) having an average particle diameter (D50) of about 60 nm are mixed in a weight ratio of 3:1 to prepare a catalyst, and 0.25 g of the catalyst is added to 2 g of an NMP solution including 7 wt % of a polyvinylidene fluoride binder and then, mixed therewith, preparing a negative electrode catalyst layer composition. This composition is coated on a nickel film current collector with a bar coater and vacuum-dried, preparing a precipitation-type negative electrode having a negative electrode catalyst layer on a current collector.

(3) Manufacturing of Final all-Solid-State Battery Cell

The prepared positive electrode, negative electrode, and solid electrolyte layer are cut, a solid electrolyte layer is stacked on the positive electrode, and then a negative electrode is stacked thereon. The obtained stack is sealed in the form of a pouch and compressed with a warm isostatic press (WIP) at a high temperature of 85° C. with 500 MPa for 30 minutes, manufacturing an all-solid-state battery cel. In the compressed state, the positive electrode active material layer has a thickness of about 100 μm, the negative electrode catalyst layer has a thickness of about 7 μm, and the solid electrolyte layer has a thickness of about 60 μm.

### Examples 2 to 9 and Comparative Examples 1 to 2

A positive electrode and an all-solid-state battery cell were manufactured in the same manner as in Example 1 except that the weight ratio of octyl acetate (OA) and pentyl propionate (PPP) was changed as shown in Table 1 in preparing the positive electrode composition.

TABLE 1

| | OA | PPP |
|---|---|---|
| Example 1 | 5 | 5 |
| Example 2 | 6 | 4 |
| Example 3 | 7 | 3 |
| Example 4 | 8 | 2 |
| Example 5 | 9 | 1 |
| Example 6 | 4 | 6 |
| Example 7 | 3 | 7 |
| Example 8 | 2 | 8 |
| Example 9 | 1 | 9 |
| Comparative Example 1 | 10 | 0 |
| Comparative Example 2 | 0 | 10 |

### Evaluation Example 1: Detection of Dispersion Medium at Positive Electrode

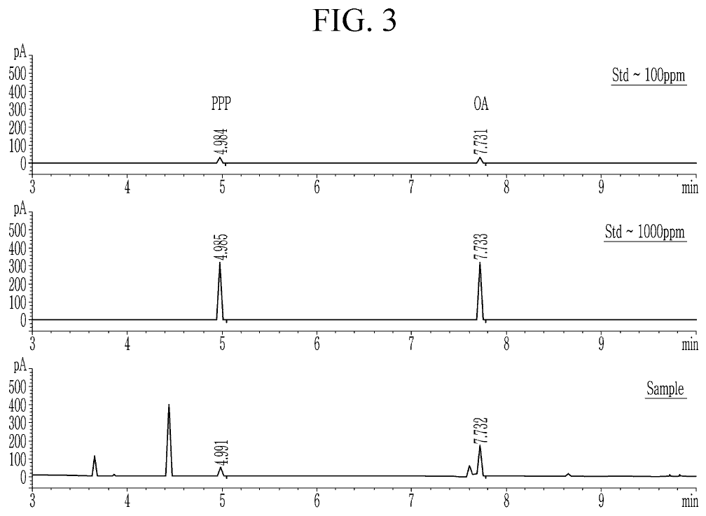

After separating the positive electrode active material layer from the all-solid-state battery cell of Example 1, the positive electrode active material layer was analyzed with respect to components in an extraction method, and the results are shown in FIG. 3.

The extraction method was performed as follows. After scraping off 0.5 g of the positive electrode plate from the all-solid-state battery cell of Example 1, the positive electrode plate was dipped in 2 mL of a diethyl carbonate (DEC) solution, After performing ultrasonic dispersion for 30 minutes, the solution was filtered with a 0.25 μm polytetrafluoroethylene (PTFE) filter. The obtained material was component-analyzed by using GC/FID (Gas Chromatography-Flame Ionization Detector). The gas chromatography was performed under the following conditions.
(1) Column: RTX-200 (30 m×320 μm, 1 um)
(2) Flow: 4 mL/min
(3) Inlet: 210° C.
(4) Oven temp.: 50/0-10-250/0, 5:1

In FIG. 3, a first graph from the top is for 100 ppm of a standard sample, and a second graph is for 1000 ppm of the standard sample. In FIG. 3, the bottom graph is a graph analyzing the positive electrode of Example 1 in the above method.

Referring to FIG. 3, in the positive electrode plate of Example 1, it was confirmed that peaks corresponding to octyl acetate (OA) and pentyl propionate (PPP) were detected. In addition, compared with a peak area of the standard sample graph, a content of the corresponding dispersion medium could be derived. Referring to FIG. 3, in the positive electrode plate of Example 1, the octyl acetate and the pentyl propionate were confirmed to be detected within a range of less than or equal to 1000 ppm, that is, less than or equal to 0.1 wt %, for example, 0.01 wt % to 0.1 wt %.

### Evaluation Example 2: Evaluation of Initial Charge and Discharge Performance of All-Solid-State Battery Cell

The all-solid-state battery cells according to the examples and the comparative examples were evaluated with respect to initial charge and discharge performance.

The results of the all-solid-state battery cells of Example 1 and Comparative Example 1 are shown as a voltage graph to specific capacity in FIG. 4. The manufactured all-solid-state battery cells of Example 1 and Comparative Example 1 were charged to an upper limit voltage of 4.25 V at a constant current of 0.1 C and discharged to a cut-off voltage of 2.5 V at 0.1 C at 45° C. for initial charge and discharge (a red graph of FIG. 4), Subsequently, the cells were charged at 0.1 C and discharged at 0.33 C within the same voltage range as a second cycle (an orange graph of FIG. 4). Then, the cells were charged at 0.1 C and discharged at 1.0 C within the same voltage range as a third cycle (a green graph of FIG. 4).

Referring to FIG. 4, Comparative Example 1 exhibited much higher battery resistance from the first charge and discharge cycle at a low rate of 0.1 C/0.1 C. This is understood to be resulted from an increase in resistance of the positive electrode plate, because when the positive electrode plate of Comparative Example 1 was dried at 80° C. in the convection oven for 10 minutes, the octyl acetate was not sufficiently evaporated but remained in a content of greater than 1000 ppm. From the second and third high-rate charge/discharges, it was confirmed that the resistance had much more influences, significantly decreasing capacity and an average voltage.

The all-solid-state battery cells of Examples 1 to 6 and Comparative Examples 1 and 2 were thirdly charged and discharged in the same manner as above to evaluate 1 C discharge capacity and calculate an average voltage, and the results are shown in Table 2,

TABLE 2

| | | | 1 C discharge | Average |
|---|---|---|---|---|
| | | | capacity | voltage |
| | OA | PPP | (mAh/g) | (V) |
| Example 1 | 5 | 5 | 179 | 3.533 |
| Example 2 | 6 | 4 | 178 | 3.522 |
| Example 3 | 7 | 3 | 173 | 3.488 |
| Example 4 | 8 | 2 | 171 | 3.456 |
| Example 5 | 9 | 1 | 170 | 3.402 |
| Example 6 | 4 | 6 | 178 | 3.531 |
| Comparative Example 1 | 10 | 0 | 168 | 3.348 |

| | | | |
|---|---|---|---|
| Comparative Example 2 | 0 | 10 | No experiment possible |

Referring to Table 2, the cells of Examples 1 to 6, compared with the cells of the comparative examples, were confirmed to exhibit improved initial discharge capacity and average voltage. As in Comparative Example 2, if the content of octyl acetate was reduced or absent, because a binder was not dissolved and the like, it was impossible to prepare a positive electrode composition or coat an electrode plate and thereby, perform a comparison experiment itself.

### Evaluation Example 3: Evaluation of Battery Cycle-Life Characteristics

The cells of Example 1 and Comparative Example 1, which were initially charged and discharged as in Evaluation Example 2, were 50 times charged at 0.33 C and discharged at 0.33 C within a voltage range of 2.5 V to 4.25 V at 45° C. to evaluate cycle-life characteristics, and the results are shown in FIG. 5.

Referring to FIG. 5, the cell of Example 1 exhibited capacity retention of greater than or equal to 90% at the 50^{th} cycle, which confirmed improved cycle-life characteristics, compared with the cell of Comparative Example 1.

Although preferred embodiments have been described in detail above, the scope of the present invention is not limited thereto. In addition, it should be understood that various modifications and improvements by those skilled in the art using the basic concept defined in the claims also fall within the scope of the present invention.

### DESCRIPTION OF SYMBOLS

100: all-solid-state battery
200: positive electrode
201: positive electrode current collector
203: positive electrode active material layer
300: solid electrolyte layer
400: negative electrode
401: negative electrode current collector
403: negative electrode active material layer
400′: precipitation-type negative electrode
404: lithium metal layer
405: negative electrode catalyst layer
500: elastic layer

1. A positive electrode for an all-solid-state battery, comprising a current collector, and a positive electrode active material layer on the current collector, wherein the positive electrode active material layer includes a positive electrode active material, a sulfide-based solid electrolyte, a binder, a conductive material, a compound represented by Chemical Formula 1, and a compound represented by Chemical Formula 2: 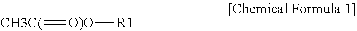
R1 is a C7 to C9 alkyl group, 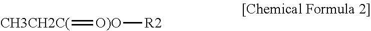
R2 is a C5 to C9 alkyl group.

2. The positive electrode for an all-solid-state battery as claimed in claim 1, wherein the compound represented by Chemical Formula 1 is included in an amount of less than or equal to 0.1 wt % based on a total weight of the positive electrode active material layer.

3. The positive electrode for an all-solid-state battery as claimed in claim 1, wherein the compound represented by Chemical Formula 2 is included in an amount of less than or equal to 0.1 wt % based on a total weight of the positive electrode active material layer.

4. The positive electrode for an all-solid-state battery as claimed in claim 1, wherein a weight ratio of the compound represented by Chemical Formula 1 and the compound represented by Chemical Formula 2 is 1:9 to 9:1.

5. The positive electrode for an all-solid-state battery as claimed in claim 1, wherein a weight ratio of the compound represented by Chemical Formula 1 and the compound represented by Chemical Formula 2 is 4:6 to 9:1.

6. The positive electrode for an all-solid-state battery as claimed in claim 1, wherein the positive electrode active material layer further includes a compound represented by Chemical Formula 3: 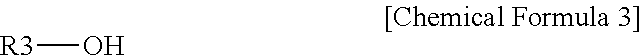
R3 is a C5 to C9 alkyl group.

7. The positive electrode for an all-solid-state battery as claimed in claim 6, wherein the compound represented by Chemical Formula 3 is included in an amount of less than or equal to 0.1 wt % based on a total weight of the positive electrode active material layer.

8. The positive electrode for an all-solid-state battery as claimed in claim 1, wherein 65 to 99 wt % of the positive electrode active material and 1 to 35 wt % of the sulfide-based solid electrolyte are included based on a total weight of the positive electrode active material and the sulfide-based solid electrolyte.

9. The positive electrode for an all-solid-state battery as claimed in claim 1, wherein the positive electrode active material includes a compound represented by Chemical Formula 12: 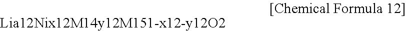
wherein, in Chemical Formula 12, 0.9≤a12≤1.8, 0.3≤x12≤1, 0≤y12≤0.7, and M14 and M15 are each independently at least one element selected from Al, B, Ba, Ca, Ce, Co, Cr, F, Fe, Mg, Mn, Mo, Nb, P, S, Si, Sr, Ti, V, W, and Zr.

10. The positive electrode for an all-solid-state battery as claimed in claim 1, wherein the sulfide-based solid electrolyte is an argyrodite-type sulfide-based solid electrolyte.

11. The positive electrode for an all-solid-state battery as claimed in claim 1, wherein the positive electrode active material layer includes, based on a total weight of the positive electrode active material, the sulfide-based solid electrolyte, the binder, and the conductive material,
65 wt % to 95 wt % of the positive electrode active material;
4 wt % to 30 wt % of the sulfide-based solid electrolyte;
0.5 wt % to 5 wt % of the binder; and
0.1 wt % to 5 wt % of the conductive material.

12. An all-solid-state battery, comprising
the positive electrode of claim 1,
a negative electrode, and
a solid electrolyte layer between the positive electrode and the negative electrode.

13. The all-solid-state battery as claimed in claim 12, wherein the negative electrode includes a current collector and a negative electrode catalyst layer on the current collector,
wherein the all-solid-state battery includes a lithium metal layer formed between the current collector and the negative electrode catalyst layer during initial charging.

14. The all-solid-state battery as claimed in claim 12, wherein the solid electrolyte included in the positive electrode and the solid electrolyte included in the solid electrolyte layer include the same compound.

15. The all-solid-state battery as claimed in claim 12, wherein
an average particle diameter (D50) of the solid electrolyte included in the positive electrode is smaller than an average particle diameter (D50) of the solid electrolyte included in the solid electrolyte layer,
an average particle size (D50) of the solid electrolyte included in the above positive electrode is 0.5 to 2.0 μm, and
an average particle size (D50) of the solid electrolyte included in the solid electrolyte layer is 2.1 μm to 5.0 μm.

16. A positive electrode composition for an all-solid-state battery, comprising a positive electrode active material, a sulfide-based solid electrolyte, a binder, a conductive agent, and a dispersion medium, wherein the dispersion medium includes a compound represented by Chemical Formula 1 and a compound represented by Chemical Formula 2: 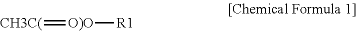
R1 is a C7 to C9 alkyl group, 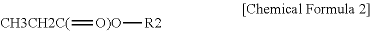
R2 is a C5 to C9 alkyl group.

17. The positive electrode composition as claimed in claim 16, wherein
the dispersion medium is included in an amount of 5 to 80 parts by weight of based on 100 parts by weight of a total amount of the positive electrode active material, the sulfide-based solid electrolyte, the binder, and the conductive agent.

18. The positive electrode composition as claimed in claim 16, wherein the dispersion medium is included in an amount of 15 parts by weight to 65 parts by weight based on 100 parts by weight of a total amount of the positive electrode active material, the sulfide-based solid electrolyte, the binder, and the conductive agent.

19. The positive electrode composition as claimed in claim 16, wherein a weight ratio of the compound represented by Chemical Formula 1 and the compound represented by Chemical Formula 2 is 4:6 to 9:1.

20. The positive electrode composition as claimed in claim 16, wherein
based on a total weight of the positive electrode active material, the sulfide-based solid electrolyte,
65 wt % to 95 wt % of the positive electrode active material;
4 wt % to 30 wt % of the sulfide-based solid electrolyte;
0.5 wt % to 5 wt % of the binder; and
0.1 wt % to 5 wt % of the conductive material.
